(19) United States
(12) Patent Application Publication
(10) Pub. No.: US 2006/0066645 A1
(43) Pub. Date: Mar. 30, 2006

(54) Method and apparatus for providing a pulse width modulation sequence in a liquid crystal display

(76) Inventor: Sunny Yat-san Ng, San Jose, CA (US)

Correspondence Address: Henneman & Saunders, 714 W. Michigan Ave., Three Rivers, MI, 49093, US

(21) Appl. No.: 10/949,703

(22) Filed: Sep. 24, 2004

(51) Int. Cl. G09G 5/10

(52) U.S. Cl. 345/691

(57) ABSTRACT

A method for converting a compound data word 10 into a modified data word (12). The compound data word (10) has a plurality of equally weighted thermometer data bits (14) and a plurality of binary weighted data bits (16). The thermometer data bits (14) are repeated in the modified data word (12). In one embodiment, the thermometer data bits (14) are asserted first, then the binary weighted data bits (16), and then the thermometer data bits (14) again, with the second assertion of the thermometer data bits (14) being in reverse order as compared to the first assertion thereof. The weight of the thermometer data bits (14) is optionally changed to keep the relative weighting of the thermometer data bits (14) and the binary weighted data bits (16) unchanged. A display driver circuit (53) in a video display apparatus (50) has a modified data generator (54) for generating the modified data words (12), and a pulse generation and routing circuitry (56) for generating pulses and providing the pulses to a plurality of pixel electrodes (58) of a display (60).

### BACKGROUND OF THE INVENTION

1. Field of the Invention

This invention relates generally to liquid crystal display devices, and more particularly to a method and apparatus for driving a display device, which will reduce undesirable artifacts such as flicker. A predominant current usage of the inventive pulse width modulation sequence is for the improvement of liquid crystal display devices used for displaying dynamic images, which require rapid and frequent updating of the image data.

2. Description of the Background Art

A liquid crystal display apparatus includes a great plurality of pixel storage elements, generally at least one for each pixel of the display. The pixel storage elements accept and hold, for a period of time, a voltage. The voltage from each pixel storage element is provided to a corresponding pixel electrode, and the intensity of the display on that pixel is a function of that voltage. For example, the liquid crystal material in the display will rotate the polarization of light passing there through, the degree of rotation depending upon the magnitude of the voltage asserted on the electrode.

A common way to provide the voltage to the pixel storage elements is via pulse-width-modulation (“PWM”). In PWM, different gray scale levels are represented by multi-bit words (i.e., binary numbers). The multi-bit words are converted to a series of pulses, whose time-averaged effective voltage corresponds to the analog voltage necessary to attain the desired gray scale value. The effective voltage will be referred to herein as the root mean square (“RMS”) voltage. By way of example, in a 4-bit PWM scheme, the frame time (time in which a gray scale value is written to every pixel) is divided into 15 time intervals. During each interval, a signal (high such as 5 V, or low such as 0 V) is asserted on the pixel storage element. In such an example, there are, therefore, 16 (0-15) different gray scale values possible, depending upon the number of intervals within which the signal is high. When the voltage does not go high during any of the intervals, this corresponds to a gray scale value of 0 (RMS 0 V). When the voltage is high during all of the 15 intervals, this corresponds to a gray scale value of 15 (RMS 5 V). When the voltage is high during intermediate quantities of the intervals, this corresponds to intermediate gray scale levels.

FIG. 1 is a diagrammatic example of a series of pulses corresponding to the 4-bit gray scale value (1010 in this particular example), where the most significant bit is the far left bit (B3). In this example of binary-weighted pulse-width modulation, the pulses are grouped to correspond to the bits of the binary gray scale value. Specifically, the first group B3 includes 8 intervals (2³), and corresponds to the most significant bit of the value (1010). Group B2 includes 4 intervals (2²), corresponding to the next most significant bit, group B1 includes 2 intervals (2¹), corresponding to the next most significant bit, and group B0 includes 1 interval (2⁰), corresponding to the least significant bit.

According to this arrangement, any quantity (0 through 15) of the intervals can be made to “go high” using only a maximum of 4 pulses, one for each bit of the binary gray scale value, with the width of each pulse corresponding to the significance of its associated bit. Thus, for the value (1010), the first pulse B3 (8 intervals wide) is high, the second pulse B2 (4 intervals wide) is low), the third pulse B1 (2 intervals wide) is high, and the last pulse B0 (1 interval wide) is low. This series of pulses results in an RMS voltage that is approximately \sqrt{⅔} (10 of 15 intervals) of the full value (5 V), or approximately 4.1 V.

It is known in the art that differing signals on adjacent pixel cells can cause visible artifacts in an image. In order to improve this situation a combination of binary weighted bits (“binary bits”) and equally weighted bits (“thermometer bits”) has been used. U.S. Pat. No. 6,151,011, issued to Worley, III et al., teaches this improvement in the art and is incorporated herein by reference in its entirety. The equally weighted thermometer bits can have the same weight as the most significant bit of the binary bits, although this is not a necessary aspect of either the prior art nor of the present invention.

A number of other undesirable artifacts can also be present in an image presented from an LCD display. Among these is a phenomenon known in the art as “flicker”. It is known that the flicker problem can be improved by increasing the frequency at which the voltages are applied to the pixel storage elements. The rate at which the data words are repeated is referred to as the “refresh rate”. Because it is known that a high refresh rate tends to alleviate the flicker problem, it is known in the art to provide the data words to the pixel storage elements at a high refresh rate. However, the available bandwidth for writing data to the display is a limitation on the refresh rate.

U.S. Pat. No. 5,940,142, issued to Wakitani, et al., teaches a method and apparatus for dividing data words by, “ . . . dividing one or more sub-fields having the highest luminance value and subsequent luminance values in descending order among plural sub-fields into a plurality of sub-field parts from a sub-field, and . . . disposing the plurality of sub-field parts in the field period separately.” That is, Wakitani, et al. teaches dividing at least some of the binary weighted bits into two portions, and then separating the resulting “sub-fields” in the assertion order. Wakitani, et al. addresses some of the problems discussed above, in that the increased number of “sub-field parts” will effectively produce at least some equally weighted bits. Also, if only some of the most significant sub-fields are divided according to the Wakitani, et al. invention, then such action will result in a greater total quantity of parts per data word. However, since the additional number of sub-field parts will only increase by one for each sub-field that is divided in two, then the total number of sub-field parts can only be as great as twice the number of binary bits, and then only if all of the sub-fields were so divided.

Also, it should be noted that, according to the teachings of Wakitani, et al., there will be pairs of equally weighted bits for each “sub-field” that is divided into two equal “sub-field parts”. This is similar in result, in that one respect, to the equally weighted “thermometer bits” of Worley, III et al. However, it should be noted that the method of Wakitani, et al. will never result in a large plurality of equally weighted bits. Since the equally weighted bits of Wakitani, et al. are created in pairs, the greatest quantity of bits that can have equal weight will be three, in a case where the next lesser significant bit is not converted, and two in a case where the next lesser significant bit is converted. That is, according to Wakitani, et al., the only way to derive as many as three equally weighted bits (“sub-field parts”) would be to divide a particular sub-field into two equally weighted parts, and not divide the next lower order subfield, such that the quantity of the two new sub-field parts plus the one undivided lower order subfield, all having the same weight, would equal three. Therefore, while Wakitani, et al. does provide some similar advantage to that of the thermometer bits of Worley, III et al., it does not provide as great an advantage in that regard as does the prior art of Worley, III et al.

It would be desirable to have a way to increase the refresh rate within the constraints of available bandwidth. It would also be desirable to have a way to reduce flicker within the constraints of available bandwidth. However, prior to the present invention, the inventor believes that no such method or means of the prior art has been as effective in this regard as the present invention.

### SUMMARY

The present invention overcomes the problems discussed above in relation to the prior art. An object of the invention is to increase the refresh rate in a liquid crystal display apparatus, thereby achieving the advantages associated with an increased refresh rate, without significantly adversely effecting other aspects of the display or the operation of the LCD apparatus. Additional advantages include improvements in several aspects of the video display.

According to the present invention, a plurality of pixel storage cells in a liquid crystal display are driven with voltages which are a function of a respective distinct data word. Each data word contains a plurality of bits, some of which are binary-weighted bits, and some of which are thermometer (equally-weighted) bits. According to an example of the invention, the thermometer bits of each data word are repeated, while the binary bits are not repeated. Since the binary bits have only a minimal effect on the effective voltage provided to the pixel storage cell, there is little or no perceptible effect on the gray scale level. However, according to the present invention, the thermometer bits are repeated more often than they might otherwise be, given bandwidth limitations, if the data words (containing both thermometer and binary bits) were repeated in their entirety. This effectively increases the refresh rate, thereby alleviating the problems associated with the refresh rate being too slow.

A method is described wherein data is arranged for presentation according to the present invention. In one embodiment of the invention, the value of thermometer bits is reduced such that repeating the thermometer bits more times than the binary bits does not change the relative average value over time of the thermometer bits as compared to that of the binary bits.

In a described embodiment of the invention, the thermometer bits are presented first, then the binary bits, then the thermometer bits again. In this example, the thermometer bits are presented the second time in reverse order, as compared to the first order of presentation.

The above-described and other objects and advantages of the present invention will become clear to those skilled in the art in view of the description of modes of carrying out the invention, and the industrial applicability thereof, as described herein and as illustrated in the several figures of the drawing. The objects and/or advantages discussed herein are not intended to be an exhaustive listing of all possible objects or advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the above described objects and/or advantages. Accordingly, any objects and/or advantages which are discussed herein are not essential elements of the present invention, and should not be construed as limitations.

### BRIEF DESCRIPTION OF THE DRAWINGS

FIG. 1 (prior art) is a diagrammatic representation of an example of a single frame of pulse-width modulated data;

FIG. 2a is a block diagram showing the weight and position of an example of a data word having both thermometer bits and binary weighted bits;

FIG. 2b is a block diagram showing an example of a data word having the thermometer bits thereof repeated;

FIG. 3 is a flow chart depicting an example of the present inventive method;

FIG. 4 is a more detailed view of an example of one step of the method of FIG. 3; and

FIG. 5 is a block diagram depicting an example of a physical implementation of the present inventive method.

### DETAILED DESCRIPTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention. For example, all or part of the present invention may be implemented in software, by dedicated driver circuitry, or by some combination thereof.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

The present invention overcomes the problems associated with the prior art, by providing a system and method for arranging data pulses in an LCD display such that undesirable artifacts are eliminated and/or reduced.

FIG. 2a is a block diagram representing an example of a data word 10 arrangement; and FIG. 2b is an example of a modified data word 12 arrangement such as might be implemented according to the present invention. The example data word 10 arrangement of FIG. 2a has a quantity m (three, in this example) of equally weighted thermometer bits 14, and a quantity n (three, in this example) of binary weighted binary bits 16. A bit number row 18 denotes an identifying number for each of the six bits 14 and 16. A bit weighting row 20 indicates a relative weight of each of the bits 14 and 16 and, therefore, the relative amount of time the bit 14 or 16 value is to be asserted on a pixel electrode. Note that each of the bits 14 and 16 has a particular value (1 or 0) as depicted in a bit value row 22. In this example, the value of the bits 14 and 16 is 1, 0, 0, 0, 1, 0, reading from left to right, as depicted in the example of FIG. 2a.

In the examples of the data words 10 and 12 of FIGS. 2a and 2b, the order of presentation of the bits is from left to right. Therefore, in the example of FIG. 2a, the thermometer bits 14 numbered 6, 5 and then 4 are asserted in that order, followed by the binary bits 16 numbered 3, 2 and then 1, in that order. As can be appreciated by a comparison of the bit number rows 18 to the bit weighting rows 20, each of the binary bits 16 has a significance of one-half the next most significant bit, as is the nature of binary weighted data bits.

The inventor has found that undesirable dynamic artifacts, such as adverse dynamic contouring effects, can be reduced by increasing the quantity of thermometer bits 14 in relation to the quantity of binary bits 16. An example of such an arrangement is seen in the modified data word 12 of FIG. 2b.

As can be seen in the example of FIG. 2b, the modified data word 12 has twice the quantity of thermometer bits 14 as compared to the example data word arrangement 10 of FIG. 2a, while retaining the same quantity of binary bits 16 as compared to the example data word arrangement 10 of FIG. 2a. In this example each of the thermometer bits 14 from the example data word arrangement 10 of FIG. 2a is repeated. Note that the example values (digital 1 or 0) of the thermometer bits 4, 5 and 6 are not changed when the thermometer bits 14 are repeated Further, in this example, thermometer bits 14 are repeated in reverse order as compared to the original presentation order. That is, in this present example, the thermometer bits are first presented, as discussed above, in the order 6, then 5, then 4. In the example of the modified arrangement 12 of FIG. 2b, the thermometer bits 14 are repeated after the binary bits 16 in the order 4, then 5, then 6. Although the reverse ordering of the thermometer bits 14 is believed to contribute to the reduction of dynamic artifacts, the order of thermometer bits 14 (as well as other features of the invention, if not explicitly stated otherwise) is not considered to be a necessary aspect (essential element) of the invention.

As can also be seen in the view of FIG. 2b, the bit weighting (as indicated by the values in the bit weighting row 20) of the thermometer bits 14 is one half the bit values of the corresponding thermometer bits 14 in the example of FIG. 2a. According to this embodiment of the invention, the thermometer bits 14 can asserted twice in the modified data word 12 without changing the relative weight of the thermometer bits 14 in relation to the binary bits 16. It should be noted that it is within the scope of the invention to assert the thermometer bits 14 twice without changing the value, as in this present example. However, the inventor has found that doing so creates too great a change in asserted voltage for some small changes in the binary value of the data word 10. Therefore, it is presently thought that such an embodiment would not be particularly useful in most applications.

In practice, either the prior art data word 10, or the inventive modified data word 12 can be asserted more than once within a given time period. However, in light of the previous description, it can be appreciated that repeating the modified data word 12 as many times as possible given a fixed bandwidth will result in the thermometer bits 14 each being asserted more times than would the assertion of the prior art data word 10 as many times as possible, given the same bit assertion rate and the same refresh time period.

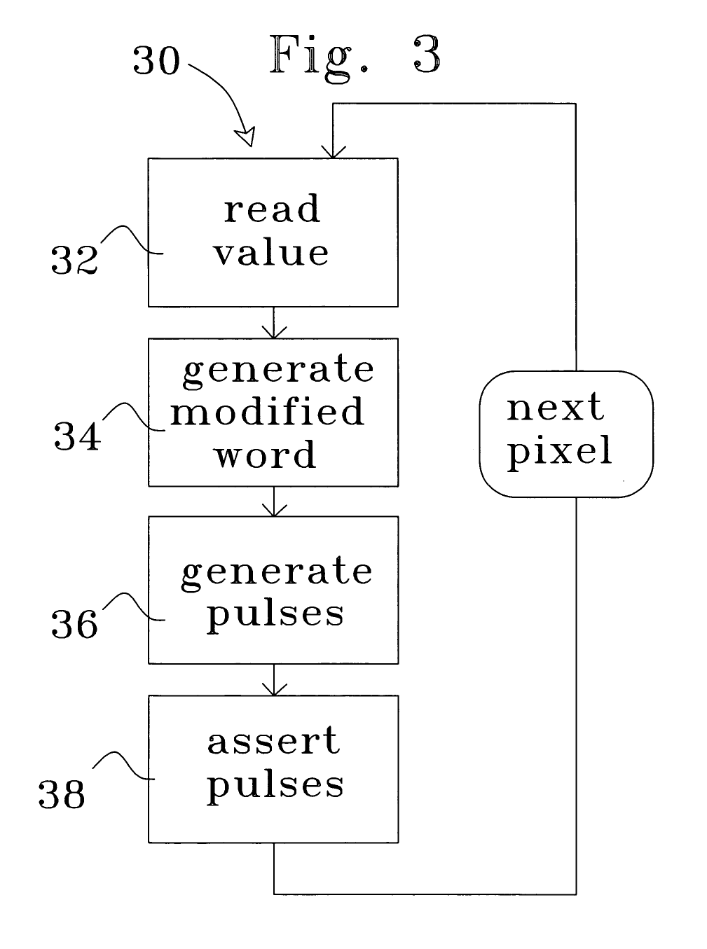

FIG. 3 is a flow diagram depicting an example of the inventive data word modification method 30. In a “read gray scale value” 32 operation, data for controlling the intensity of a given pixel is read. The instant value read is generated by digital video driver circuitry, and this operation is not different from the corresponding step in known prior art methods. The value will generally be a simple n bit data word. In a “generate modified data word operation” 34 the value previously read in the “read gray scale value” 32 operation is modified and arranged according to the present inventive method. While it is conceivable that the “generate modified data word” operation 34 could be accomplished using a software controlled digital processing apparatus, according to the present state of the technology dedicated logic circuitry is used. One skilled in the art will recognize that numerous variations of logic circuitry could be used to arrange the modified data word 12 (FIG. 2b) as described herein, and one skilled in the art could readily devise such a circuit adapted for the particular word size, bit arrangement, and the like, as might be required for use with a particular application of the invention. One skilled in the art will recognize that, given the limitations of present technology and the rapidity with which the pulses must be generated from the original gray scale value, it is common practice to “map” the pulse values, as in a look up table or dedicated mapping circuitry. Therefore, in many instances of the practice of the invention, the “generate modified data word” operation 34 is accomplished merely by the mapping operation.

Alternatively, because the modified data words include repeated iterations of a group of thermometer bits having particular values, it is possible to generate a modified data word by storing the group of thermometer bits once, but reading the thermometer bits out of storage more than once. For example, compound data word 10 can be stored in 6 bits of a frame buffer. Then, modified data word 12 can be generated by retrieving and writing thermometer bits 14 to a pixel, retrieving and writing binary bits 16 to the pixel, and then retrieving and writing bits 14 to the pixel again. Thus, modified data word 12 can be generated dynamically (e.g., by a driving routine), without ever having to be stored in a 9-bit memory location.

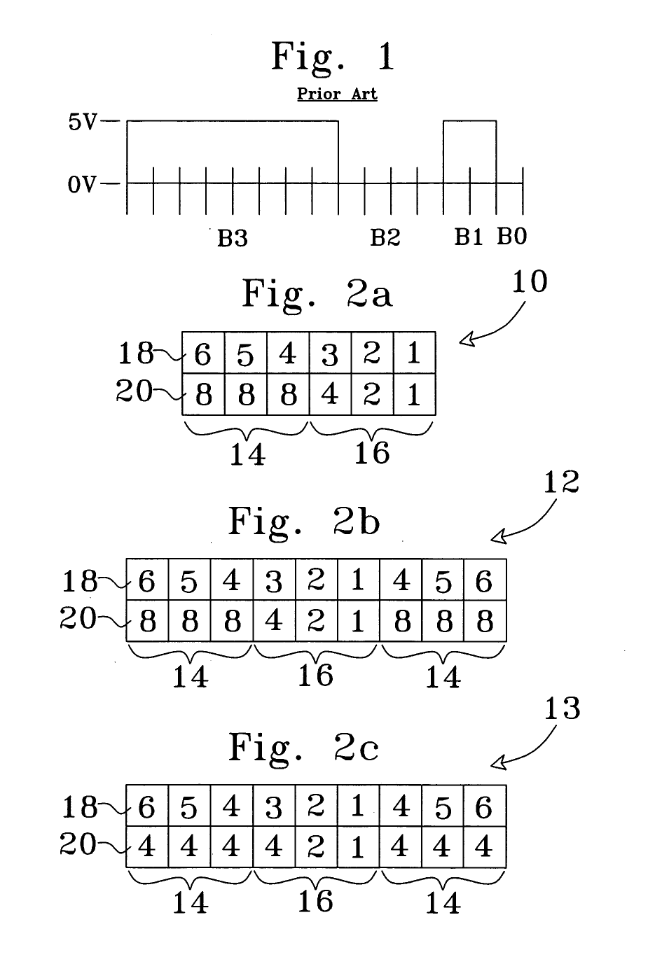

Next, the modified data word 12 is converted to equivalent voltage pulses in a “convert word to voltage” operation 36 (such as is illustrated in the prior art example of FIG. 1). As previously discussed herein, according to the example of FIG. 2b, the thermometer bits 14 would be asserted at one half of their weighted value, as compared to the unmodified example of FIG. 2a. Then, the pulses are asserted on the appropriate pixel in an “assert pulses” operation 38. The entire data word modification method 30 is repeated for each pixel in the display for each “frame” of the video.

It should be understood that generate pulses operation 36 and the assert pulses operation 38 can occur generally simultaneously, can somewhat overlap, and/or be considered to part of a single operation. For example, in one embodiment the pulses are generated and asserted by loading data bits into a storage latch associated with a pixel electrode, and then asserting the data bit (or a voltage determined by the data bit) onto the pixel electrode for a time dependent on the significance of the latched data bit. U.S. Pat. No. 6,067,065, issued to Worley, III et al., describes various such methods for generating and asserting pulses on pixel electrodes, and is incorporated herein by reference in its entirety.

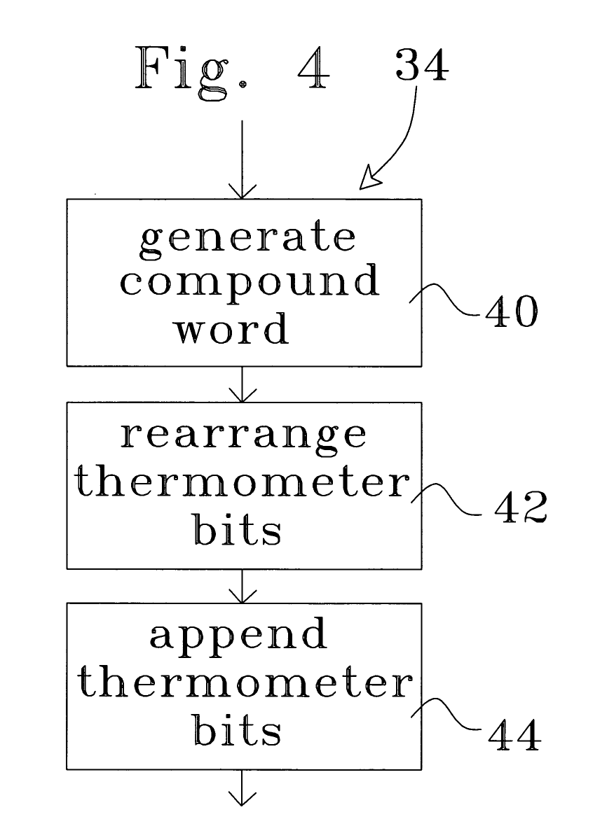

FIG. 4 is a more detailed flow diagram of an example of the previously discussed “generate modified data word” operation 34. In the example of FIG. 4, in the “generate compound data word” operation 40, a compound data word (such as the example of FIG. 2a) is generated. The compound data word has both thermometer bits 14 and binary bits 16, and is generated according to the method described in the Worley, III et al. '011 patent, discussed previously herein. In a rearrange thermometer bits operation 42 the thermometer bits 14 (FIG. 2b) are optionally changed in value and, optionally, rearranged. In an append thermometer bits operation 44, the thermometer bits 14 are appended at the end of the modified data word 12 (FIG. 2b). As previously discussed herein, if the modified data words 12 are mapped, then the procedure discussed here in relation to FIG. 4 will be replaced with the single mapping operation.

One skilled in the art will recognize that, in the practice of the invention, the operations of the methods described herein in relation to FIGS. 3 and 4 will not necessary be performed in the order suggested by the single loop structure of these simple examples. Indeed, in order to accomplish these operations in the required time, it will generally be necessary that the operations of one such loop begin before the previous loop is complete. That is, in at least some applications, the data for one loop will be read, and the modified words generated, while (or even before) the previous iteration of the loop is completed. Furthermore, in actual practice, the order of presentation of the bits generated in each of the loops can be considerably more complicated. In the previously referenced Worley, III et. al '011 patent, several examples of circuitry for asserting bits of generated words are discussed in detail. The practice of the present invention is quite similar to that taught in that issued patent, with the exception that the modified data words 12 (FIG. 2b) are generated and asserted instead of the compound data words 10 (FIG. 2a).

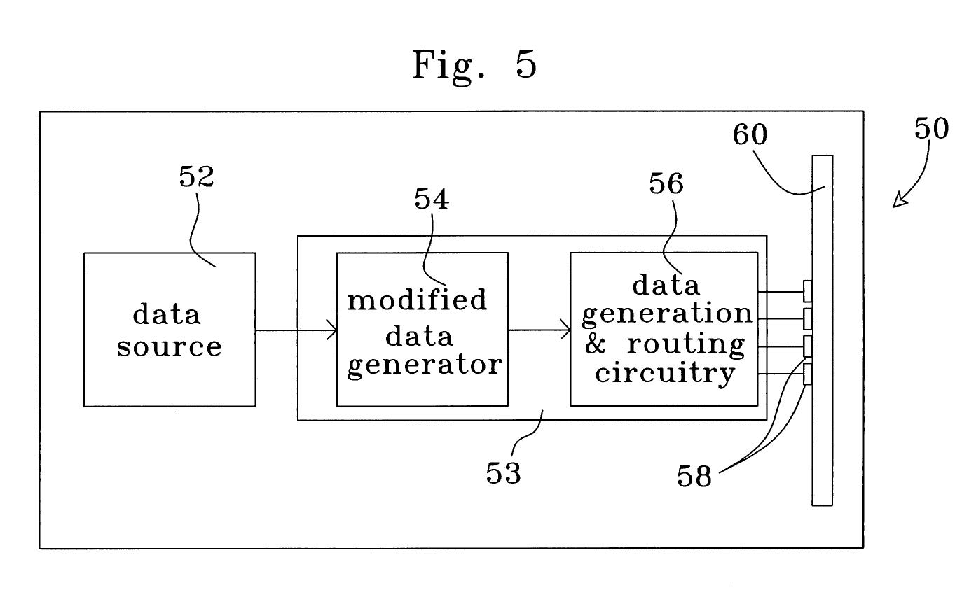

FIG. 5 is a block diagram of an example of a video display apparatus 50 such as might implement the present inventive method. One skilled in the art will recognize that the video display apparatus 50 (a video projector, or the like) will include a great many components which will not be specifically shown or discussed herein. Rather, the example of the block diagram of FIG. 5 is intended only to illustrate those aspects of the video display apparatus 50 which are relevant to the implementation of the present invention.

A data source 52 will provide the gray scale data which is operated upon according to the present inventive method, as discussed previously herein. The data source can optionally be or include a data port such that the data is provided to the video display apparatus 50 from an external source. Alternatively, the data can be generated within the video display apparatus 50. A display drive circuit 53 has a modified data generator 54 for generating the modified data words 12 (FIG. 2b). The remainder of the display drive circuit 53 includes a pulse generator and routing circuitry for generating and asserting pulses upon a plurality (only four of the great plurality are shown in the diagram of FIG. 5) of pixel electrodes 58 of a video display apparatus 50 (a micro LCD in this example). In the presently described embodiment of the invention, the pulses are generated and asserted by the pulse generator and routing circuitry 56 as described in the Worley, III et. al '011 patent and the Worley III et al. '065 patent, although this is not a necessary aspect of the present invention.

All of the above are only some of the examples of available embodiments of the present invention. Those skilled in the art will readily observe that numerous other modifications and alterations may be made. Many of the described features may be substituted, altered or omitted without departing from the spirit and scope of the invention. For example, the order of assertion of the thermometer bits might be varied from that of the specific example discussed. Another obvious variation would be to use some combination of dedicated logic circuitry and general purpose processors to arrange the data as described herein. These and other deviations from the particular embodiments shown will be apparent to those skilled in the art, particularly in view of the foregoing disclosure. Therefore, one skill in the art could readily create variations of the invention to adapt it according to the needs or convenience of a particular application. Accordingly, this disclosure is not intended as limiting, and the appended claims are to be interpreted as encompassing the entire scope of the invention.

NOTICE: This correspondence chart is provided for informational purposes only. It is not a part of the official Patent Application.

### Correspondence Chart

10 DATA WORD
12 MODIFIED DATA WORD
14 THERMOMETER BITS
16 BINARY BITS
18 BIT NUMBER ROW
20 BIT WEIGHTING ROW
22 BIT VALUE ROW
30 DATA WORD MODIFICATION METHOD
32 READ GRAY SCALE VALUE OPERATION
34 GENERATE MODIFIED DATA WORD OPERATION
36 CONVERT WORD TO VOLTAGE OPERATION
38 ASSERT PULSES OPERATION
40 GENERATE COMPOUND DATA WORD OPERATION
42 REARRANGE THERMOMETER BITS OPERATION
44 APPEND THERMOMETER BITS OPERATION
50 VIDEO DISPLAY APPARATUS
52 DATA SOURCE
53 DISPLAY DRIVER CIRCUIT
54 MODIFIED DATA GENERATOR
56 PULSE GENERATION AND ROUTING CIRCUITRY
58 PIXEL ELECTRODES
60 DISPLAY

I claim:

1. A method for providing data to a video display apparatus, comprising:
accepting display data from a data source;
parsing the display data into at least one compound data word, said compound data word having a plurality of binary weighted data bits and a plurality of equally weighted data bits;
forming a modified data word wherein said binary weighted data bits are each included once, and further wherein said equally weighted data bits are each included more than once.

2. The method of claim 1, wherein:
said equally weighted data bits are included twice in said modified data word.

3. The method of claim 1, wherein:
said modified data word includes, in order, said equally weighted data bits, said binary weighted data bits, and then said equally weighted data bits again.

4. The method of claim 1, wherein:
said modified data word includes said equally weighted data bits presented in a first order of assertion; and
said modified data word further includes said equally weighted data bits presented in a second order of assertion.

5. The method of claim 4, wherein:
said second order of assertion is an inverse order as compared to said first order of assertion.

6. The method of claim 1, and further including:
generating a plurality of electrical pulses wherein said pulses correspond to the weight and value of each of the data bits in the modified data word.

7. The method of claim 6, and further including;
asserting said electrical pulses on a pixel storage element.

8. The method of claim 1, wherein:
the quantity of equally weighted data bits is greater than three.

9. An electronically readable-medium having code embodied therein operable to cause an electronic device to perform the steps of the method of claim 1.

10. An electronically readable-medium having code embodied therein operable to cause an electronic device to perform the steps of the method of claim 2.

11. An electronically readable-medium having code embodied therein operable to cause an electronic device to perform the steps of the method of claim 3.

12. An electronically readable-medium having code embodied therein operable to cause an electronic device to perform the steps of the method of claim 4.

13. An electronically readable-medium having code embodied therein operable to cause an electronic device to perform the steps of the method of claim 5.

14. An electronically readable-medium having code embodied therein operable to cause an electronic device to perform the steps of the method of claim 6.

15. An electronically readable-medium having code embodied therein operable to cause an electronic device to perform the steps of the method of claim 7.

16. An electronically readable-medium having code embodied therein operable to cause an electronic device to perform the steps of the method of claim 8.

17. In a video display apparatus, an improvement comprising:
a data modification apparatus for compiling data words wherein each of said data words has a plurality of thermometer data bits and also a plurality of binary data bits; wherein
said plurality of thermometer data bits is included in each data word more than once.

18. The video display apparatus of claim 17, wherein:
said thermometer data bits are included twice in each of said data words.

19. The video display apparatus of claim 17, wherein:
said thermometer data bits are asserted in a first order in said data words; and
said thermometer bits are repeated in a second order in said data words.

20. The video display apparatus of claim 19, wherein:
said second order is the reverse of said first order.

21. The video display apparatus of claim 17, wherein:
the quantity of thermometer data bits is greater than three.

22. A video projector apparatus, comprising:
a data source; and
a modified data word generator operative to convert data from said data source to into a modified data word; and wherein
each of said modified data words has a plurality of thermometer data bits and also a plurality of binary data bits; and
said plurality of thermometer data bits is included in each data word more than once.

23. The video display apparatus of claim 22, wherein:
said thermometer data bits are included twice in each of said data words.

24. The video display apparatus of claim 22, wherein:
said thermometer data bits are asserted in a first order in said data words;
said thermometer bits are repeated in a second order in said data words.

25. The video display apparatus of claim 24, wherein:
said second order is the reverse of said first order.

26. The video display apparatus of claim 22, wherein:
the quantity of thermometer data bits is greater than three.

27. A method for generating a modified data word comprising the steps of:
providing a first group of data bits, said bits of said first group being of like significance with respect to each other;
providing a second group of data bits, said bits of said second group differing in significance with respect to each other; and
combining the first group of data bits and the second group of data bits to form the modified data word, wherein said second group of data bits is included once and further wherein said first group of data bits is included more than once.

28. The method of claim 27, wherein:
the first group of data bits is included in the modified data word first in a first sequence and then in a second sequence.

29. The method of claim 27, wherein:
the modified data word includes, in order, the first group of data bits, then the second group of data bits, and then the first group of data bits.

30. The method of claim 27, wherein:
the quantity of data bits in the first group of data bits is greater than three.

31. An electronically readable-medium having code embodied therein operable to cause an electronic device to perform the steps of the method of claim 27.

32. An electronically readable-medium having code embodied therein operable to cause an electronic device to perform the steps of the method of claim 28.

33. An electronically readable-medium having code embodied therein operable to cause an electronic device to perform the steps of the method of claim 29.

34. An electronically readable-medium having code embodied therein operable to cause an electronic device to perform the steps of the method of claim 30.

35. A video projection apparatus comprising:
a display including a plurality of pixel storage locations; and
a driver circuit, coupled to said display, for writing a modified data word to said display, said modified data word comprising a first group of data bits and a second group of data bits, wherein said first group of data bits is repeated within said modified data word.

36. A method for asserting voltages in a data storage device, comprising:
converting binary data into a plurality of pulses; wherein at least some of said pulses are binary weighted pulses which correspond in value to a plurality of binary bits of the binary data; and
at least some said pulses are thermometer pulses which have equally weighted values in relation to each other; and
said thermometer pulses are each asserted more than once during a time period within which each of said binary weighted pulses are each asserted only once.

37. The method of claim 36, wherein:
said thermometer pulses are all asserted first;
said binary pulses are all asserted next; and
said thermometer pulses are again all asserted.

38. The method of claim 36, wherein:
said thermometer pulses are all asserted in a first order;
said binary pulses are all asserted next; and
said thermometer pulses are again all asserted in a second order.

39. The method of claim 38, wherein:
said second order is the reverse of said first order.

40. The method of claim 36, wherein:
the value of said thermometer pulses is a function of the value of the most significant bit of the binary data.

41. The method of claim 36, wherein:
the width of said thermometer pulses is the same as the most significant bit of said binary pulses.

42. The method of claim 36, wherein:
the width of said thermometer pulses is a multiple of the width of the most significant bit of said binary pulses.

43. The method of claim 36, wherein:
the width of said thermometer pulses is a fixed fraction of the width of the most significant bit of said binary pulses.

44. The method of claim 36, wherein:
the quantity of said thermometer pulses is greater than three.

45. An electronically readable-medium having code embodied therein operable to cause an electronic device to perform the steps of the method of claim 36.

46. An electronically readable-medium having code embodied therein operable to cause an electronic device to perform the steps of the method of claim 37.

47. An electronically readable-medium having code embodied therein operable to cause an electronic device to perform the steps of the method of claim 38.

48. An electronically readable-medium having code embodied therein operable to cause an electronic device to perform the steps of the method of claim 39.

49. An electronically readable-medium having code embodied therein operable to cause an electronic device to perform the steps of the method of claim 40.

50. An electronically readable-medium having code embodied therein operable to cause an electronic device to perform the steps of the method of claim 41.

51. An electronically readable-medium having code embodied therein operable to cause an electronic device to perform the steps of the method of claim 42.

52. An electronically readable-medium having code embodied therein operable to cause an electronic device to perform the steps of the method of claim 43.

53. An electronically readable-medium having code embodied therein operable to cause an electronic device to perform the steps of the method of claim 44.
